(19) United States
(12) Patent Application Publication
(10) Pub. No.: US 2023/0241572 A1
(43) Pub. Date: Aug. 3, 2023

(54) STIRRING DEVICE AND METHOD FOR OPERATING A STIRRING DEVICE

(71) Applicant: EKATO Rühr-und Mischtechnik GmbH, Schopfheim (DE)

(72) Inventors: Wolfgang LAST, Lörrach (DE); Marco KÖNIG, Schopfheim (DE); Konstantin EPP, Lörrach (DE); Josef WAGNER, Schopfheim (DE); Alexander PESCHL, Mainz (DE)

(21) Appl. No.: 18/007,729

(22) PCT Filed: May 31, 2021
(86) PCT No.: PCT/EP2021/064577

§ 371 Date: Dec. 1, 2022

(30) Foreign Application Priority Data
Jun. 4, 2020 (DE) 10 2020 114 809.7

(51) Int. Cl. B01J 19/00; B01J 19/12; B01J 19/08

(52) U.S. Cl. CPC B01J 19/0066; B01J 19/006; B01J 19/122; B01J 19/08; B01J 2219/00481; B01J 2219/00763

(57) ABSTRACT

A stirring device, in particular a reactor stirring device, comprises a radiation unit which is configured for irradiating a medium. wherein the stirring device comprises a guide tube unit which is configured for separating two opposing flows of the medium.

### PRIOR ART

The invention relates to a stirring device according to the preamble of claim 1, a stirrer with at least one stirring device according to claim 13, and a method for operating a stirring device according to the preamble of claim 16, in particular for initiating and/or maintaining a chemical reaction, especially a chlorination.

From plastics chemistry is known to chlorinate polyvinyl chloride (PVC) in a stirrer tank by irradiation with ultraviolet light to form C-PVC. For this purpose, a UV lamp is used, which is fixed to the stirrer tank.

It is the objective of the invention, in particular, to provide a generic device with improved properties with respect to effectiveness, that is to say, in particular with respect to an irradiation and/or with respect to a flow guide, that is to say, in particular with respect to a path length of a medium in a radiation area, in particular for maximizing a contact time and/or for maximizing an average density of radiation and/or for maximizing an amount of radiation absorbed by the medium. The objective is achieved according to the invention by the features of claims 1 and 14 while advantageous implementations and further developments of the invention will become apparent from the dependent claims.

### ADVANTAGES OF THE INVENTION

The invention is based on a stirring device, in particular a reactor stirring device, with a radiation unit which is configured for irradiating a medium.

It is proposed that the stirring device has a guide tube unit which is configured for separating two opposing flows of the medium.

By such an implementation, improved properties with respect to effectiveness, that is to say, particularly in the context of photochemical processes, which in particular have a low quantum yield, can be achieved. In particular, by the implementation according to the invention advantageous properties with respect to a flow and/or with respect to an irradiation when mixing and/or stirring can be achieved. Furthermore, advantageously, a high degree of efficiency, that is to say in particular with respect to an irradiation and/or a flow, can be achieved. In particular, advantageously, a high homogeneity of an irradiation and/or of a flow rate can be achieved. In particular dead spaces can be avoided. Furthermore, advantageously, a homogeneous flow, in particular inside and outside a guide tube, can be achieved. In particular, component effectiveness can also be increased.

A “stirring device” is understood to mean an, in particular functioning, component, in particular a structural and/or functional component of a stirrer, in particular of a reactor, alternatively or additionally of a stirrer tank and/or a stirring installation. The stirring device is configured for a processing, in particular at least for a homogenization, suspension, emulsification and/or gassing, of at least one medium and/or for heat transfer within at least one medium. Preferably, the stirring device is configured for a processing and/or production of a medium, for example based on the chemical reaction 2CHCl₃+Cl₂=>2CCl₄+H₂, which has at least one substance, in particular a reactant, such as, for example a plastic, preferably polyvinyl chloride. Furthermore, the medium may comprise in particular further components, such as, for example, solvents, stabilizers, pigments, catalysts, initiators, such as, for example, free-radical chain initiators, gases such as, for example, chlorine gas, and/or other plastics.

The stirring device is preferably formed as a reactor stirring device. A “reactor stirring device” is understood to mean a stirring device, which, for the processing of the medium, is configured at least for activating and/or initiating and/or maintaining a chemical reaction of the medium, such as, for example, a polymerization, a depolymerization, a photolysis, a photocatalysis, a decontamination and/or a halogenation, in particular a chlorination. Alternatively or additionally, the reactor stirring device could in particular be configured for water treatment. Preferably, the reactor device is realized as a photoreactor device. It would be conceivable that the stirring device comprises the entire stirrer and/or reactor and/or stirrer tank and/or an entire stirring installation. In particular, it would be conceivable that the stirring device that is realized as a reactor stirring device comprises the entire reactor.

The stirring device has a radiation unit, which is configured for irradiating the medium, in particular for activating and/or initiating and/or maintaining the chemical reaction of the medium. For example, the radiation unit could comprise at least one radiation element and advantageously be configured for subjecting the medium to electromagnetic radiation, in particular with electromagnetic radiation in the visible and/or in the non-visible range of the electromagnetic spectrum, in particular with non-visible UV radiation and/or visible VIS radiation. Preferably, the radiation unit can at least initiate and/or maintain the chemical reaction of the medium by means of electromagnetic radiation emitted by the radiation unit. The at least one radiation element could have, for example, a lamp, an LED and/or a laser, and preferably be realized as a lamp, as an LED and/or as a laser. In particular, the radiation unit has a plurality of, for example, at least two, advantageously at least three, particularly advantageously at least four, preferably at least six and particularly preferentially at least eight radiation elements.

In particular, the radiation unit could further have at least one enclosure for the protection of the at least one radiation element, in particular against mechanical and/or chemical stress. For example, the radiation unit could have an enclosure for the protection of all radiation elements. Preferably, the radiation unit has for each radiation element a respective enclosure for the protection of each of all the radiation elements. The at least one radiation element could be enclosed by the enclosure at least partially, preferably at least to a large extent, and particularly preferably completely, at least in the circumferential direction. The enclosure could consist at least partially, preferably at least to a large extent and particularly preferably completely of a material, which is at least translucent and/or preferably transparent for the radiation of the at least one radiation element. It would be conceivable that the enclosure is in particular embodied as a glass tube, in particular as a quartz glass tube. The expression “at least to a large extent” is understood to mean in this context by at least 55%, advantageously by at least 65%, preferably by at least 75%, particularly preferably by at least 85% and particularly advantageously by at least 95%.

The stirring device has a guide tube unit, which is configured for flow-technically separating two opposing flows of the medium. The guide tube unit is a structural unit that is configured at least partially to guide two opposing flows of the medium, in particular of a circulation flow of the medium.

Advantageously, the guide tube unit is formed at least partially as a hollow cylinder, which is configured for guiding the medium, in particular in a vertical direction, in particular at least substantially in parallel to a surface normal of a ground. “At least substantially in parallel” is understood to mean here an orientation of a direction relative to a reference direction, in particular in a plane, wherein the direction with respect to the reference direction has a deviation of in particular less than 8°, advantageously less than 5° and particularly advantageously less than 2°. In particular, a main extension direction of the guide tube unit runs vertically. Herein a “main extension direction” of the guide tube unit is understood to mean a direction which runs in parallel to a longest edge of a smallest geometric rectangular cuboid which just barely completely encloses the guide tube unit.

Alternatively or additionally, the guide tube unit could have an at least substantially angular geometry, that is to say for example an at least substantially rectangular cuboid geometry.

Preferably, the guide tube unit directly encloses, when viewed in the direction of flow, at least one flow of the two opposing flows of the medium, in particular at least partially, advantageously to a large extent, and preferably completely. In particular, the guide tube unit separates the two opposing flows of the medium passively, that is the guide tube unit separates the two opposing flows of the medium preferably structurally. Preferably, a main extension of the guide tube unit parallel to the direction of flow of at least one of the two opposing flows is at least twice, in particular at least three times, and advantageously at least four times as long as at least one cross-sectional extension of the guide tube unit. Preferably, the guide tube unit has an entry area and/or an exit area. An “entry area of the guide tube unit” is understood to mean an area of the guide tube unit, in particular an opening of the guide tube unit, in which/through which the medium enters the guide tube unit and/or is sucked into the guide tube unit. An “exit area of the guide tube unit” is understood to mean an area of the guide tube unit, in particular an opening of the guide tube unit, in which/through which the medium exits the guide tube unit and/or is discharged from the guide tube unit.

“Configured” is to mean specifically programmed, designed and/or equipped. An object being configured for a particular function is to mean that the object fulfills and/or performs this particular function in at least one application state and/or operating state.

It is further proposed that the radiation unit is at least partially formed integrally with the guide tube unit. In this way, in particular, a stirring device can be provided which provides particularly advantageous properties with respect to effectiveness. The radiation unit being formed with the guide tube unit “at least partially integrally” is to mean that the radiation unit and the guide tube unit have at least one, in particular at least two, advantageously at least three, particularly advantageously at least four, preferably at least five and particularly preferably at least six common elements that are a component, in particular a functional component, of both units. Preferably, at least part of the radiation unit is, in particular, part of the guide tube unit. In particular, at least one and preferably all radiation elements, especially the enclosures of the radiation elements, could be configured for separating and/or guiding the flows of the medium. In particular, the components of the radiation unit which are configured for separating and/or guiding of flows of the medium are in particular part of the guide tube unit.

It is further proposed that the radiation unit has at least one at least substantially transparent inner wall element and at least one at least substantially transparent outer wall element, the inner wall element and the outer wall element also being part of the guide tube unit. The phrase “at least substantially transparent” is in particular to mean, in this context, that the inner wall element and/or the outer wall element have/has for a range of wavelengths of the radiation provided by the radiation elements of the radiation unit a transmission coefficient which is advantageously at least 85%, particularly advantageously at least 90%, preferably at least 95% and particularly preferably at least 99%. In this way, in particular, an especially high effectiveness can be achieved. For example, a receiving area could be formed between the inner wall element and the outer wall element and, for example, be filled with a cooling medium, that is to say in particular with oil. In particular, the receiving area is a space between the inner wall element and the outer wall element. It would be conceivable that the cooling medium is guided by means of at least one supply element of the stirring device into the receiving area and/or out of the receiving area. For example, the at least one supply element could be part of a holding unit which is configured for holding at least the inner wall element and/or the outer wall element. Preferably, radiation elements of the radiation unit are arranged in the receiving area between the inner wall element and the outer wall element at least partially and more preferably completely. In particular, the inner wall element and/or the outer wall element are/is formed at least partially by a transparent glass or the like, in particular at least partially by quartz glass. In addition, it would be conceivable that to the inner wall element and/or to the outer wall element at least one baffle element and preferably a plurality of baffle elements is attached, for example integrally. In particular, the baffle elements are provided to maintain at least one flow as turbulent as possible.

In addition, it is proposed that the radiation unit forms at least partially a fluid-technical guide for separating the opposing flows of the medium. In particular, the radiation unit guides the opposing flows at least partially along a main extension direction of the radiation unit. “Main extension direction” of the radiation unit is to mean a direction running parallel to a longest edge of a smallest geometric rectangular cuboid which just barely completely encloses the radiation unit. In particular, in an operating state at least two at least substantially opposing flows flow around the radiation unit. By such an implementation, in particular especially high effectiveness, in particular with respect to the irradiation of the medium, can be achieved. In particular, mixing of the opposing flows of medium can be avoided by such an implementation. In this way, in particular, a particularly advantageous circulation of the medium can be achieved.

Furthermore, it is proposed that the radiation unit is configured for irradiating a volume of the medium flowing within the guide tube unit. In particular, at least one radiation element is configured and preferably all radiation elements of the radiation unit are configured for irradiating the volume of the medium flowing within the guide tube unit. By such an implementation, in particular especially high effectiveness, that is to say with respect to the irradiation of the medium, can be achieved. Furthermore, in this way, in particular, a continuous irradiation can be ensured.

Furthermore, it is proposed that the radiation unit is configured for irradiating a volume of the medium flowing outside the guide tube unit. In particular, at least one radiation element is configured and preferably all radiation elements of the radiation unit are configured for irradiating the volume of the medium flowing outside the guide tube unit.

Advantageously, the radiation unit is configured for irradiating the two opposing flows of the medium. In particular, at least one radiation element is configured and preferably all radiation elements of the radiation unit are configured for irradiating the two opposing flows of the medium. In this way, in particular, a continuous irradiation can be ensured. Furthermore, in this way a component effectiveness can be improved, that is to say, in particular in that only one radiation unit is required for irradiating two flows of the medium.

In addition, it is proposed that the radiation unit at least partially defines at least one passage area for a radial passage of the medium through the radiation unit, wherein the at least one passage area is bounded by at least two radiation elements of the radiation unit. In particular, in an operating state the medium flows through the at least one passage area in a radial direction. It would be conceivable that the radiation unit at least partially defines a plurality of, for example, at least two, advantageously at least three, particularly advantageously at least four, preferably at least six and particularly preferably at least eight passage areas for the radial passage of the medium through the radiation unit, which in each case are bounded by at least two radiation elements of the radiation unit. It would also be conceivable that the at least one passage area and preferably all of the passage areas alternatively or additionally is/are bounded at least partially by at least one further element. For example, the at least one further element, by which the at least one passage area and preferably all passage areas alternatively or additionally is/are bounded, could be realized as the guide tube unit. In this way, in particular an advantageous circulation of the medium can be achieved. Furthermore, in this way in particular an effective irradiation of the medium in the at least one passage area can be ensured.

Furthermore, it is proposed that the radiation unit comprises a plurality of radiation elements, each arranged in alignment with the guide tube unit. Advantageously, the plurality of radiation elements is arranged in such a manner that the main extension direction of the radiation element is aligned in parallel to the main extension direction of the guide tube unit. In particular, the plurality of radiation elements is arranged along a radius, which at least substantially corresponds to a radius of the guide tube unit. It would be conceivable that the radiation unit comprises a plurality of, for example, at least two, advantageously at least three, particularly advantageously at least four, preferably at least six and particularly preferably at least eight radiation elements, which are in each case arranged in alignment with the guide tube unit. Preferably, all the radiation elements of the radiation unit are arranged in each case in alignment with the guide tube unit. In this way, in particular especially advantageous flow properties, in particular with respect to the flowing medium, can be achieved. Furthermore, in this way, that is to say in particular with respect to the flowing medium, a particularly high effectiveness with respect to the irradiation can be achieved.

Furthermore, it is proposed that the stirring device has at least one holding unit, which fastens at least one radiation element of the radiation unit to at least one guide tube element of the guide tube unit. In this way, in particular a stirring device can be provided which has advantageous properties with respect to a stability. In particular, at least one radiation element of the radiation unit is connected with at least one guide tube element of the guide tube unit by means of the at least one holding unit. At least one radiation element of the radiation unit being “connected” with at least one guide tube element of the guide tube unit is understood to mean that the radiation element advantageously is connected with the guide tube element at least by a force fit and/or at least a form fit, for example by a riveting and/or by a latching connection and/or by a tongue-and-groove connection and/or by a clamp connection and/or by a further connection that appears reasonable to a person skilled in the art, and/or is connected with the guide tube element by substance-to-substance bond, for example by a welding process, a gluing process, an injection-molding process and/or another process that appears reasonable to the person skilled in the art. In particular, the guide tube unit comprises at least one guide tube element. Preferably, the guide tube unit has a plurality of guide tube elements, for example, at least two, advantageously at least three, particularly advantageously at least four, preferably at least six, and particularly preferably at least eight guide tube elements. The guide tube element, is in particular formed as a segment of a tubular piece. The guide tube element could in particular be formed integrally with at least one other element of the guide tube unit. Alternatively or additionally, the guide tube element could be formed as a metal sheet, alternatively or additionally as a plastic sheet. Preferably, the guide tube element could have an at least substantially flat, in particular planar, and/or alternatively or additionally a round, in particular bent shape. It would be conceivable alternatively or additionally that the guide tube element is formed as an at least partially curved plate and/or as an at least partially curved sheet. In particular, the holding unit could be at least part of the radiation element of the radiation unit and/or of the guide tube element of the guide tube unit. In this way, in particular the radiation element of the radiation unit could be connected directly with the guide tube element of the guide tube unit. “Directly connected” is to mean, in this context, at least adjoining in a form-fitting manner and/or connected while avoiding further components.

In addition, it is proposed that the guide tube unit has at least one receiving area for at least partially receiving at least one radiation element of the radiation unit. In this way, advantageous properties with respect to a fluid-technical flow guide can be achieved. Furthermore, a high level of space effectiveness can be achieved by such an implementation. For example, the receiving area of the guide tube unit could be formed as a rectangular, round or oval recess. Preferably, the radiation unit and the guide tube unit overlap at least partially with respect to an axial direction.

Furthermore, it is proposed that the stirring device has at least one agitator that is arranged at least substantially within the guide tube unit. In this way, in particular a high level of effectiveness can be achieved. Furthermore, a particularly advantageous separation of the flows can be made possible. Particularly advantageously, the agitator is configured for being rotated about an axis of rotation, in particular when stirring and/or mixing. Preferably, viewed along a stirring shaft of the agitator, the agitator is formed to be point-symmetrical, in particular with respect to a longitudinal extension of the stirring shaft.

Advantageously, in an assembled state, in particular in a normal operating state of the stirring device, the stirring shaft extends in a vertical direction, preferably in the direction of acting gravity, wherein preferably the vertical direction is perpendicular to a ground. For example, the agitator could be part of a stirring unit, which is arranged at least partially within the guide tube unit. For example, at least 40%, advantageously at least 50%, particularly advantageously at least 60%, preferably at least 70%, and particularly preferably all of the agitator could be arranged within the guide tube unit. In particular, the stirring unit could comprise a further element, which is arranged at least substantially outside the guide tube unit. Particularly preferably, the stirring device has at least one hub element that is in particular arranged centrally. In particular, the hub element projects at least partially into the guide tube unit. Particularly preferably, the axis of rotation runs through the hub element. Advantageously, the stirring unit, in particular the hub element of the stirring unit, is configured for mounting on at least one drive shaft. Particularly advantageously, the hub element is connected with the drive shaft by means of a force-fitting and/or form-fitting connection, for example by means of clamps and/or screws and/or a tongue-and-groove connection. However, it is also conceivable that the stirring unit, in particular the hub element of the stirring unit, is connected integrally with the drive shaft. “Integrally” is to mean at least connected by substance-to-substance bond, for example by a welding process, a gluing process, an injection-molding process and/or another process that appears reasonable to the person skilled in the art, and/or advantageously formed in one piece, such as for example, by production from a cast and/or by production in a one-component or multi-component injection-molding process, and advantageously made from a single blank. Preferably, the stirring device is made at least to a large extent from a material resistant to, in particular organic, solvents and/or acids and/or bases, in particular of ceramics or of a ceramic composite. Particularly preferably, the stirring unit is made at least to a large extent of a metal and/or of a metal alloy, in particular steel and/or stainless steel. It is also conceivable, however, that the stirring unit is made to at least to a large extent of a plastic. Furthermore, it is conceivable that the stirring unit has an at least partial, in particular additional, coating, for example with a metal oxide and/or an, in particular corrosion-resistant, polymer, and/or is realized in a rubberized fashion. Preferably, a conveying direction runs at least substantially in parallel to the axis of rotation.

Furthermore, it is proposed that the stirring device has at least one further radiation unit, which is configured for an irradiation of the medium, and which is arranged radially outside the guide tube unit. The further radiation unit has, in particular any number of, further radiation elements. The further radiation unit in particular has a greater radial distance from an axis of rotation of the agitator than the guide tube unit. In particular, the further radiation elements of the further radiation unit have a greater radial distance from the axis of rotation of the agitator than the guide tube unit. It would be conceivable that the radiation elements of the radiation unit and the further radiation elements of the further radiation unit are formed identically. Such an implementation in particular allows providing improved properties with respect to an effectiveness, in particular in the context of photochemical processes.

In order to achieve a particularly high effectiveness, furthermore a stirrer, in particular a reactor, is proposed, with a container and with at least one stirring device which is at least partially arranged in the container. The container could in particular be formed rotationally symmetrically, and preferably at least substantially in a cylindrical shape. An inner wall of the container in particular forms a cylinder casing of the container. The container has, in particular, a preferably domed cover and/or bottom, which are/is connected with the container wall. The cover and/or the bottom may in particular be connected integrally with the container wall. Alternatively or additionally, the cover and/or the bottom may be connected with the container wall in a force-fitting and/or form-fitting manner. It would be conceivable that the stirrer, in particular the reactor, has at least one gas inlet, for example in a lower, central area, and/or at least one gas outlet, for example in a lower, decentral area, in particular for an inlet and/or outlet of gas, such as for example chlorine gas. It would also be conceivable that the stirrer, in particular the reactor, has at least one metering unit, in particular for metering at least one catalyst substance. Furthermore, it would be conceivable that the stirrer, in particular the reactor, has at least one inlet and/or at least one outlet, in particular for an inlet and/or outlet of at least one substance, in particular the medium, preferably for executing a continuous operation of the reactor.

In addition, it is proposed that the radiation unit comprises a plurality of radiation elements which are spaced apart from an inner wall of the container by at least 20% of a radius of the container. This enables, in particular, an advantageous and in particular two-sided flow around of the radiation elements. Furthermore, a particularly high effectiveness can be achieved in this way. Furthermore, a particularly high degree of efficiency can be achieved by such an implementation. In particular, the radiation unit has a plurality of, for example, at least four radiation elements, advantageously at least five radiation elements, particularly preferably at least six radiation elements, preferably at least eight radiation elements, and particularly preferably at least ten radiation elements. The radius of the container is, in particular in the case of a rotationally symmetrical container, a distance between the axis of rotation of the container and the inner wall of the container. The plurality of radiation elements are arranged spaced apart from the inner wall of the container by at least 20% of the radius of the container. In particular, the plurality of radiation elements is arranged spaced apart from the inner wall of the container, for example by at least 30%, advantageously by at least 40%, particularly advantageously by at least 45%, preferably by at least 50% and particularly preferably by at least 55% of the radius of the container.

Furthermore, it is proposed that the radiation unit is fastened at least to a first axial end area of the container and that the guide tube unit is fastened at least to at least one second axial end area of the container that is situated opposite said first axial end area. This allows achieving particularly advantageous properties with respect to a stability. Preferably, the radiation unit is fastened at least to an upper axial end area of the container. Preferably, the guide tube unit is fastened at least to a lower axial end area of the container. It would be conceivable that the radiation unit and the guide tube unit additionally are connected with one another in a central area of the container.

The invention is furthermore based on a method for operating a stirring device, which has at least one radiation unit by means of which a medium is irradiated.

It is proposed that a relative residence time of the medium in an effective range of the radiation unit is extended in that the radiation unit is on both sides flown around by opposing flows of the medium. For example, a “relative residence time of the medium in an effective range of the radiation unit” may be a residence time of the medium in the effective range of the radiation unit per flow cycle of the medium.

In particular, the method according to the invention enables a particularly high effectiveness. In particular, especially advantageous properties with respect to an efficient and/or effective activation and/or initiation and/or maintaining of the chemical reaction of the medium can be achieved.

Furthermore, it is proposed, that, following an irradiation by the radiation unit, the medium, in particular free radicals in the medium, is/are transported into an area outside the effective range of the radiation unit, in particular into an upper and/or lower area of the container, in particular such that there the free radicals can also act. This allows a reaction efficiency to be increased further.

The stirring device according to the invention and the stirrer with the stirring device according to the invention shall not be limited to the above-described application and embodiment. In particular, for a fulfillment of a functionality that is described here, the stirring device according to the invention and the stirrer with the stirring device according to the invention may have a number of individual elements, components and units that differs from a number mentioned herein. In addition, the method according to the invention for operating a stirring device shall not be limited to the above-described application and implementation. In particular, for a fulfillment of a functionality that is described here, the method according to the invention for operating a stirring device may have a number of individual method steps that differs from a number mentioned herein.

### DRAWINGS

Further advantages will become apparent from the following description of drawings. Three exemplary embodiments of the invention are illustrated in the drawings. The drawings, the description and the claims contain numerous features in combination.

Expediently, the person skilled in the art will look at each of the features also individually and will combine them to form other meaningful combinations.

FIG. 1 shows a stirrer with a stirring device in a perspective sectional view,

FIG. 2 shows a portion of the stirrer with the stirring device and with a radiation unit in a perspective sectional view,

FIG. 3 shows a portion of the stirrer with the stirring device and with the radiation unit and with an agitator in a sectional top view,

FIG. 4 shows a flow chart of a method for operating the stirring device,

FIG. 5 shows a further exemplary embodiment of a stirrer with a stirring device in a simplified cross-sectional representation,

FIG. 6 shows a portion of the stirrer with the stirring device with a guide tube unit in a sectional top view,

FIG. 7 shows a portion of the stirrer with the stirring device and with an intermediate space between an inner wall element and an outer wall element of the guide tube unit,

FIG. 8 shows another exemplary embodiment of a stirrer with a stirring device in a simplified cross-sectional representation, and

FIG. 9 shows a portion of the stirrer with the stirring device, which has a radiation unit and a further radiation unit, in a simplified sectional top view.

### DESCRIPTION OF THE EXEMPLARY EMBODIMENTS

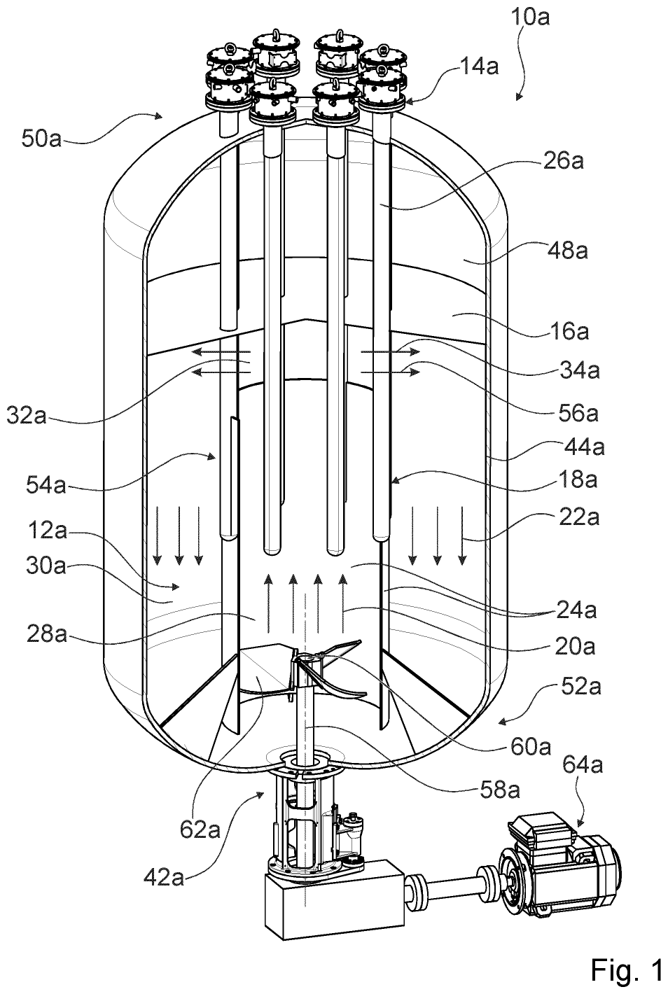

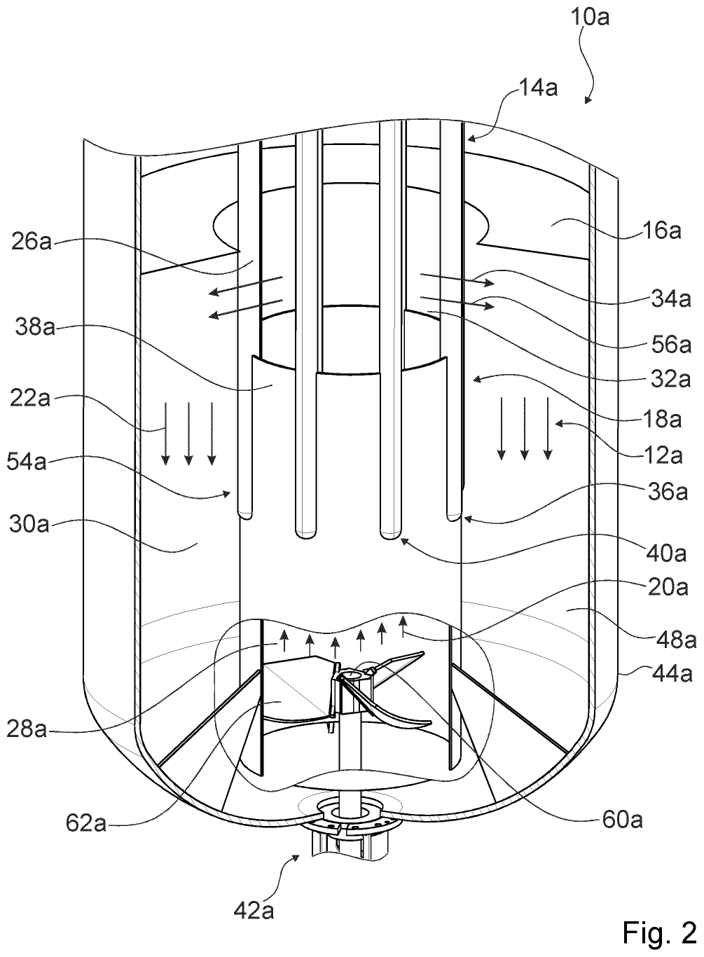

FIGS. 1 and 2 show a stirrer 10a, which is in the illustrated example formed as a reactor. The stirrer 10a has a container 44a. Merely for illustrative purposes, a sectional view of a portion of the stirrer 10a is shown in the figures by way of example, in particular to illustrate an interior of the stirrer 10a. In addition, the stirrer 10a has a stirring device 12a. In the illustrated example, the stirring device 12a is arranged at least partially in container 44a.

In the example shown, the stirring device 12a is formed as a reactor stirring device. The stirring device 12a has a radiation unit 14a. The radiation unit 14a is configured for irradiating a medium 16a. In the example shown, the radiation unit 14a is configured for irradiating a medium 16a with UV radiation. The radiation unit 14a is configured for at least initiating and/or maintaining at least one chemical reaction, for example a photochemical reaction, in particular a chlorination and/or a halogenation and/or a bromination, of the medium 16a.

The stirring device 12a also has a guide tube unit 18a. The guide tube unit 18a is configured for separating two opposing flows 20a, 22a of the medium 16a.

The radiation unit 14a comprises a plurality of radiation elements 26a. In the example shown, the radiation unit 14a comprises a plurality of eight radiation elements 26a. In the example shown, the radiation elements 26a are formed to be identical. The radiation elements 26a are each arranged in alignment with the guide tube unit 18a.

The radiation unit 14a is formed at least partially integrally with the guide tube unit 18a. This means that, as shown in FIG. 1 by way of example, a portion of each of the radiation elements 26a is formed integrally with the guide tube unit 18a. For this purpose, the radiation elements 26a each have a subsection 54a, which in each case is formed integrally with the guide tube unit 18a.

FIG. 2 shows the stirring device 12a in particular in an operating state. In the operating state, two at least substantially opposing flows 20a, 22a of the medium 16a flow around the radiation unit 14a.

In the illustrated exemplary operating state, one of the two at least substantially opposing flows 20a, 22a of medium 16a, in particular the flow 20a, flows within the guide tube unit 18a upward.

In addition, in the illustrated exemplary operating state, a second one of the two at least substantially opposing flows 20a, 22a of the medium 16a, in particular the flow 22a, flows outside the guide tube unit 18a downward.

In the operating state, the two at least substantially opposing flows 20a, 22a of the medium 16a are in a circulation.

The radiation unit 14a at least partially forms a fluid-technical guide 24a. The fluid-technical guide 24a is configured for separating the opposing flows 20a, 22a of the medium 16a.

In the example illustrated, the radiation unit 14a together with a guide tube element 38a of the guide tube unit 18a forms a fluid-technical guide 24a which is configured for separating the opposing flows 20a, 22a of the medium 16a.

Fluid-technical guide 24a separates a volume 28a of medium 16a flowing within the guide tube unit 18a from a volume 30a of medium 16a flowing outside guide tube unit 18a.

In the operating state, the radiation unit 14a is configured for irradiating the volume 28a of the medium 16a flowing within the guide tube unit 18a. That is to say, all radiation elements 26a of the radiation unit 14a are configured for irradiating the volume 28a of the medium 16a flowing within the guide tube unit 18a.

In the operating state, the radiation unit 14a is configured for irradiating the volume 30a of the medium 16a flowing outside the guide tube unit 18a, that is to say, that all radiation elements 26a of the radiation unit 14a are configured for irradiating the volume 30a of the medium 16a flowing outside the guide tube unit 18a.

Thus, the radiation unit 14a is configured for irradiating the two opposing flows 20a, 22a of the medium 16a, that is to say, for irradiating by means of UV radiation in the example shown. Alternatively or additionally, radiation with visible light would also be conceivable.

The radiation unit 14a defines a plurality of passage areas 32a. The passage areas 32a serve a radial passage 34a of the medium 16a through the radiation unit 14a. In the example illustrated, the radiation unit 14a defines a plurality of eight passage areas 32a. The passage areas 32a enable the circulation of the medium 16a in the operating state.

Each of the passage areas 32a is bounded by at least two radiation elements 26a of the radiation unit 14a. In each case two radiation elements 26a of the radiation unit 14a bound each of the passage areas 32a laterally.

In addition, the stirring device 12a has at least one holding unit 36a. The holding unit 36a fastens at least one radiation element 26a of the radiation unit 14a to at least one guide tube element 38a of the guide tube unit 18a. The holding unit 36a may be formed in any way that appears to be reasonable to the person skilled in the art. Alternatively or additionally, the holding unit 36a could be formed for example as shown in DE 10 2017 102 165 A1.

Also, the guide tube unit 18a has at least one receiving area 40a. In the example shown, the guide tube unit 18a has eight receiving areas 40a. The receiving area 40a is configured for at least partially receiving in each case at least one radiation element 26a of the radiation unit 14a. In the example illustrated, the receiving area 40a is formed as a recess of the guide tube element 38a. This means that the radiation unit 14a and the guide tube unit 18a at least partially overlap with respect to an axial direction 56a.

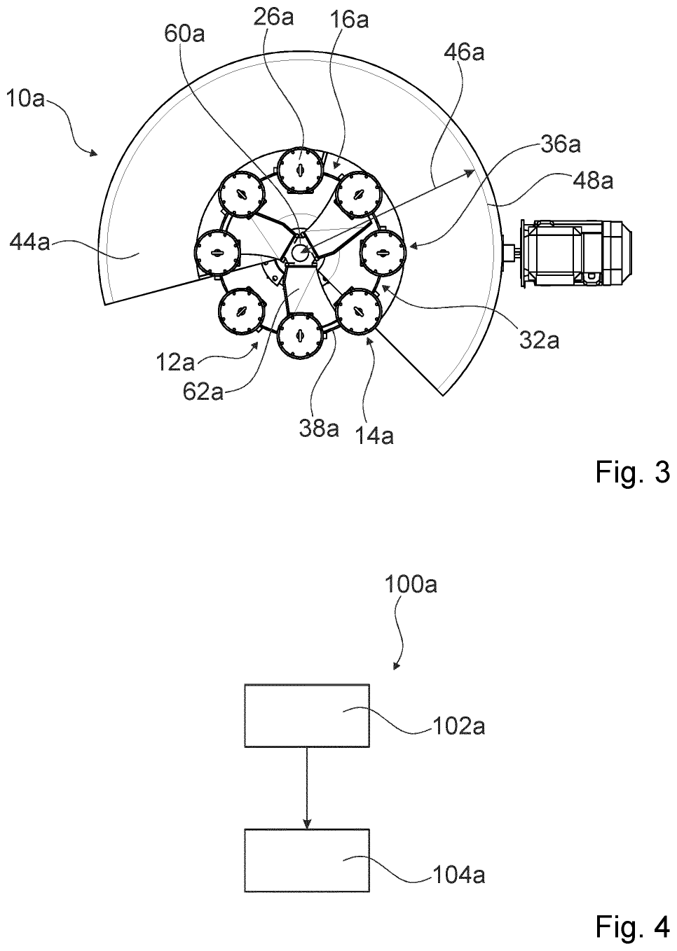

FIG. 3 shows a top view of the stirrer 10a of the preceding figures. The container 44a comprises an inner wall 48a. The plurality of, in particular eight, radiation elements 26a are arranged spaced apart from the inner wall 48a of the container 44a by at least 20% of a radius 46a of the container 44a (cf. FIGS. 1 to 3). In the example shown, the plurality of radiation elements 26a is arranged spaced apart from the inner wall 48a of the container 44a by about 55% of a radius 46a of the container 44a.

In the example shown, the container 44a has a first axial end area 50a. Opposite the first axial end area 50a, the container 44a has a second axial end area 52a. In the present case, the radiation unit 14a is fastened at least to the first axial end area 50a of the container 44a. In addition, the guide tube unit 18a is fastened at least to the second axial end area 52a of the container 44a. Thus, the radiation unit 14a and the guide tube unit 18a are fastened at least to opposite axial end areas 50a, 52a of the container 44a.

Moreover, the stirrer 10a has an agitator 42a arranged at least substantially within the guide tube unit 18a. The agitator 42a is formed to be rotatable around an axis of rotation 58a. The agitator 42a has a centrally arranged hub element 60a. Furthermore, the agitator 42a, in the present case, has three rotor blade elements 62a, wherein a different number of rotor blade elements 62a would be conceivable also. The agitator 42a is configured for conveying and/or mixing the medium 16a. For driving the agitator 42a, the stirrer 10a also has a drive unit 64a, which is formed as an electric motor.

FIG. 4 shows a flow chart of a method 100a for operating the stirring device 12a, which has at least one radiation unit 14a.

Method 100a in particular has a first method step 102a. The method 100a furthermore has a further method step 104a.

In first method step 102a, the medium 16a is irradiated by the radiation unit 14a. In the further method step 104a, a relative residence time of medium 16a in an effective range of the radiation unit 14a is increased in that opposing flows 20a, 22a of the medium 16a flow around the radiation unit 14a on both sides. Furthermore, the medium 16a is then transported to an area outside the effective range of the radiation unit 14a.

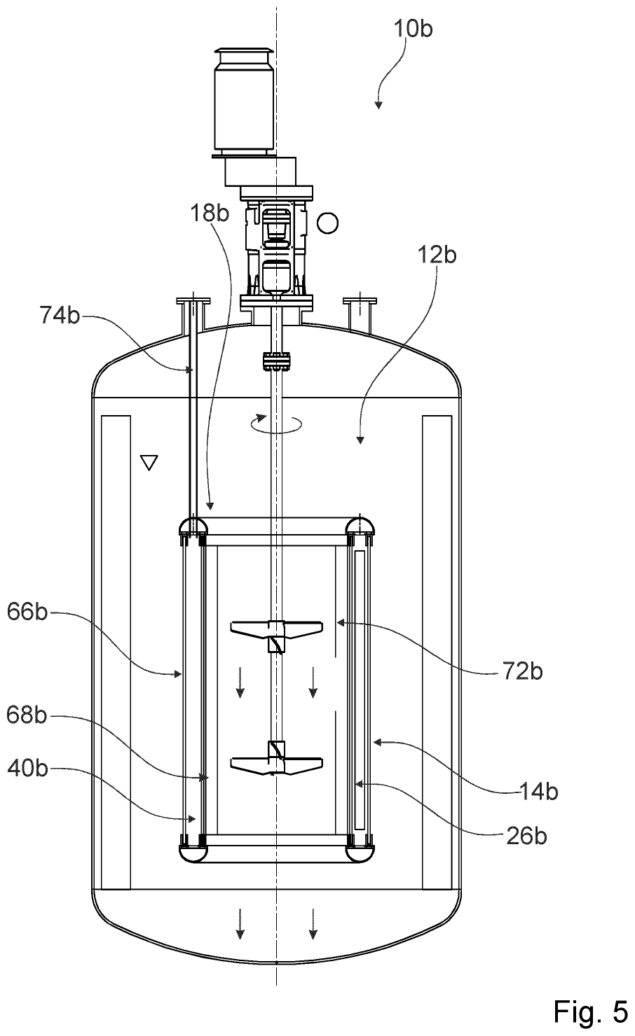

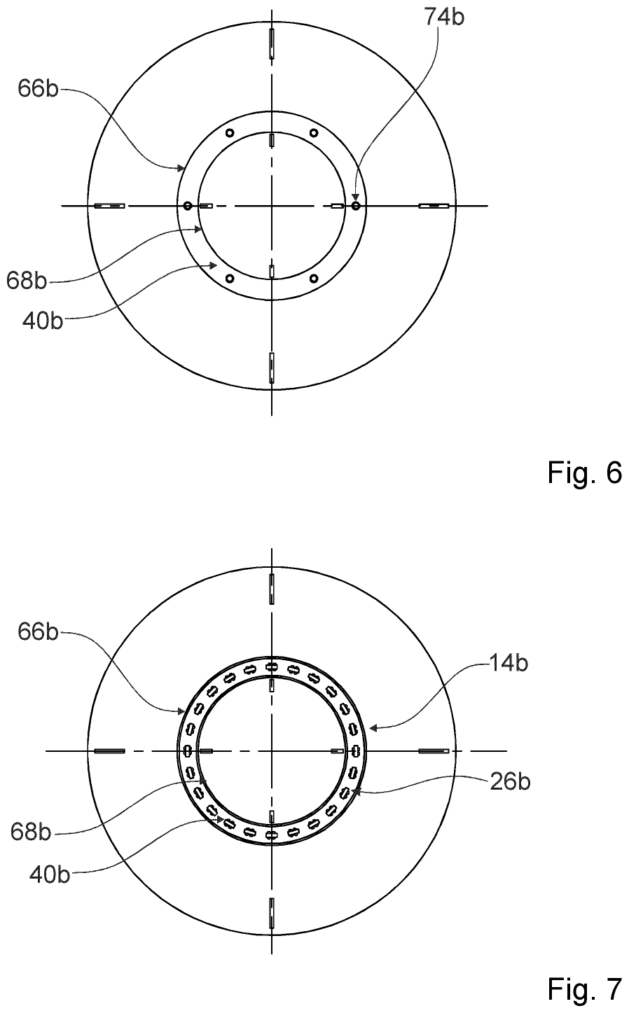

FIGS. 5 to 9 show two further exemplary embodiments of the invention. The following descriptions are essentially limited to the differences between the exemplary embodiments, where reference is made to the description of the other exemplary embodiments, in particular FIGS. 1 to 4, with respect to unchanging components, features and functions. To distinguish the exemplary embodiments, letter a in the reference numerals of the exemplary embodiment of FIGS. 1 to 4 is replaced by letters b and c in the reference numerals the exemplary embodiments of FIGS. 5 to 9. With respect to components having the same denomination, in particular with respect to components with the same reference numerals, reference can be made in principle also to the drawings and/or the description of the other exemplary embodiments, in particular of FIGS. 1 to 4.

FIGS. 5 to 7 show a further embodiment of a stirrer 10b. The stirrer 10b has a stirring device 12b.

The stirring device 12b has a radiation unit 14b. The radiation unit 14b has an inner wall element 66b that is at least substantially transparent. In addition, the radiation unit 14b has an outer wall element 68b that is at least substantially transparent. The inner wall element 66b and the outer wall element 68b are also part of a guide tube unit 18b of the stirring device 12b. The inner wall element 66b and the outer wall element 68b are formed to a large extent, in particular completely, of quartz glass.

The inner wall element 66b and the outer wall element 68b are formed at least substantially to be cylindrical and have diameters of different sizes. A receiving area 40b is arranged between the inner wall element 66b and the outer wall element 68b.

The radiation unit 14b has a plurality of radiation elements 26b. In the example illustrated, the radiation unit 14b has a number of 24 radiation elements 26b.

The radiation elements 26b are arranged in the receiving area 40b between the inner wall element 66b and the outer wall element 68b.

The stirrer 10b also has a plurality of baffle elements 72b. Some of the baffle elements 72b are fixed integrally to the inner wall element 66b.

Moreover, the receiving area 40b is cooled by means of a coolant formed as an oil. The receiving area 40b is supplied with the coolant via at least one supply line, which is part of a holding unit 74b formed as a suspension.

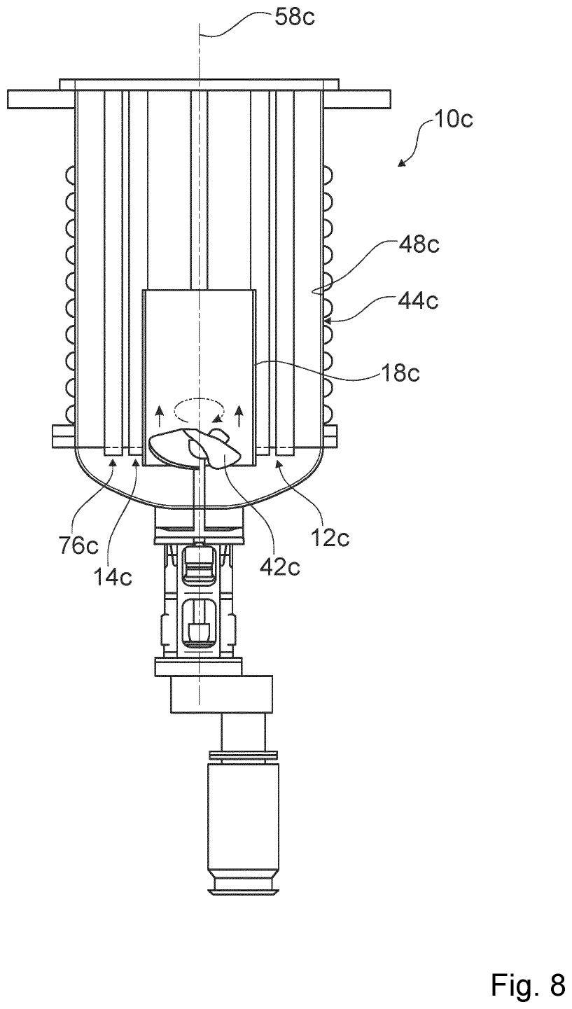

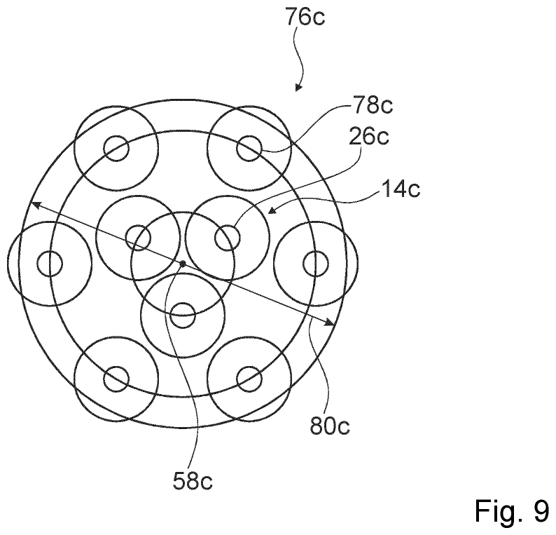

FIGS. 8 and 9 show a further exemplary embodiment of a stirrer 10c. The stirrer 10c has a stirring device 12c.

The stirring device 12c has a radiation unit 14c. The radiation unit 14c comprises a plurality of radiation elements 26c, which are each arranged in alignment with a guide tube unit 18c of the stirring device 12c.

The stirring device 12c furthermore has a further radiation unit 76c. The radiation unit 76c is configured for irradiating a medium (not shown). The radiation unit 76c is arranged radially outside the guide tube unit 18c. The radiation unit 76c is arranged radially between the guide tube unit 18c and an inner wall 48c of a container 44c of the stirrer 10c. That is to say that the radiation unit 76c is arranged in an area between the guide tube unit 18c and the inner wall 48c (cf. also FIG. 9).

The radiation unit 76c has an arbitrarily selectable number of further radiation elements 78c. In the present example, the further radiation unit 76c has six further radiation elements 78c.

The further radiation elements 78c of the further radiation unit 76c have a greater radial distance 80c from an axis of rotation 58c of an agitator 42c of the stirrer 10c than the radiation elements 26c of the radiation unit 14c.

The illustrated orientation of the stirrer 10c is exemplary, with any further orientations of the stirrer 10c being also conceivable, such as for example a horizontal orientation in which the agitator 42c is arranged to the side of the container 44c, or a reverse orientation of the stirrer 10c, in which the agitator 42c is arranged above the container 44c.

The further radiation elements 78c of the further radiation unit 76c could be fastened in particular to the container 44c in a manner known from WO 2018/141517, for example.

### REFERENCE NUMERALS

10 Stirrer
12 Stirring device
14 Radiation unit
16 Medium
18 Guide tube unit
20 Flow
22 Flow
24 Fluid-technical guide
26 Radiation element
28 Volume
30 Volume
32 Passage area
34 Radial passage
36 Holding unit
38 Guide tube element
40 Receiving area
42 Agitator
44 Container
46 Radius
48 Inner wall
50 First axial end area
52 Second axial end area
54 Subsection
56 Axial direction
58 Axis of rotation
60 Hub element
62 Rotor blade element
64 Drive unit
66 Inner wall element
68 Outer wall element
72 Baffle element
74 Holding unit
76 Further radiation unit
78 Further radiation element
80 Radial distance
100 Method
102 Method step
104 Further method step

1. A stirring device, in particular a reactor stirring device, with a radiation unit which is configured for irradiating a medium, the stirring device further comprising a guide tube unit which is configured for separating two opposing flows of the medium.

2. The stirring device according to claim 1, wherein the radiation unit is at least partially formed integrally with the guide tube unit.

3. The stirring device according to claim 1, wherein the radiation unit has at least one at least substantially transparent inner wall element and at least one at least substantially transparent outer wall element, wherein the inner wall element and the outer wall element are also part of the guide tube unit.

4. The stirring device according to claim 1, wherein the radiation unit at least partially forms a fluid-technical guide for the separation of the opposing flows of the medium.

5. The stirring device according to claim 1, wherein the radiation unit is configured for an irradiation of a volume of the medium flowing within the guide tube unit.

6. The stirring device according to claim 1, wherein that wherein the radiation unit is configured for an irradiation of a volume of the medium flowing outside the guide tube unit.

7. The stirring device according to claim 1, wherein the radiation unit at least partially defines at least one passage area for a radial passage of the medium through the radiation unit, wherein the at least one passage area is bounded by at least two radiation elements of the radiation unit.

8. The stirring device according to claim 1, wherein the radiation unit comprises a plurality of radiation elements, each arranged in alignment with the guide tube unit.

9. The stirring device according to claim 1, comprising at least one holding unit, which fastens at least one radiation element of the radiation unit to at least one guide tube element of the guide tube unit.

10. The stirring device according to claim 1, wherein the guide tube unit has at least one receiving area for at least partially receiving at least one radiation element of the radiation unit.

11. The stirring device according to claim 1, comprising at least one agitator that is arranged at least substantially within the guide tube unit.

12. The stirring device according to claim 1, comprising at least one further radiation unit, which is configured for an irradiation of the medium and is arranged radially outside the guide tube unit.

13. A stirrer, in particular a reactor, with a container and with at least one stirring device according to claim 1, which is at least partially arranged in the container.

14. The stirrer according to claim 13, wherein the radiation unit comprises a plurality of radiation elements, which are spaced apart from an inner wall of the container by at least 20% of a radius of the container.

15. The stirrer according to claim 13, wherein the radiation unit is fastened at least to a first axial end area of the container, and the guide tube unit is fastened at least to at least one second axial end area of the container that is situated opposite the first axial end area.

16. A method for operating a stirring device, in particular according to claim 1, in particular for carrying out a chemical reaction for the production, in particular for halogenation and/or chlorination, of C-PVC by means of the stirring device, which has at least one radiation unit by which a medium is irradiated, wherein a relative residence time of the medium in an effective range of the radiation unit is extended in that the radiation unit is on both sides flown around by opposing flows of the medium.

17. The method according to claim 16, wherein the medium is transported to an area outside of the effective range of the radiation unit after irradiation by the radiation unit.
